(19) United States
(12) Patent Application Publication
(10) Pub. No.: US 2005/0207820 A1
(43) Pub. Date: Sep. 22, 2005

(54) Barbeque grill oiler

(75) Inventors: Richard M. Franczak, Perth Amhoy, NJ (US); Michael J. LaSalle, Freehold, NJ (US); Francis E. McCullion JR., Old Bridge, NJ (US)

Correspondence Address: ROBERT M. SKOLNIK, 353 Monmouth Road, PO Box 22, West Long Branch, NJ, 07764-0022, US

(73) Assignee: LAMCON, a New Jersey Partnership

(21) Appl. No.: 11/049,320

(22) Filed: Feb. 2, 2005

Related U.S. Application Data
(60) Provisional application No. 60/553,453, filed on Mar. 16, 2004.

(51) Int. Cl. B05C 17/005; A46B 11/00; A47L 13/26

(52) U.S. Cl. 401/39; 401/37

(57) ABSTRACT

A liquid applicator has either a disposable or reusable container of liquid. The container is inter-fit in and held in place in an applicator on a carriage. The liquid is then permitted to flow from the container through the applicator for use on a surface. A removable handle may be snap fit onto the applicator. The applicator includes a sponge surface for contacting the surface. The sponge is attached to the carriage for the container. The carriage as a plurality of apertures formed therein to permit the liquid from the container to spread over and through the sponge. The opposite end of the applicator handle has a removable tool affixed thereto. The tool may be a wire brush, a scrapper or a squeegee.

### CROSS REFERENCE TO RELATED APPLICATIONS

This application claims the benefit of earlier filed provisional application Ser. No. 60/553,453, filed Mar. 16, 2004

### BACKGROUND OF THE INVENTION

1. Field of the Invention

The present invention relates a device for applying cooking oil to the grilling surface of a barbeque grill to aid in keeping the grill clean by preventing food from sticking to the grill and inhibiting oxidation of a metal grill. The oil must be applied when the grill is cool for both safety and effectiveness. The oil is also effective when applied to “non-stick” grill surfaces.

2. Description of the Related Art

Blum, et al, U.S. Pat. No. 2,722,701, show a window washer with fluid from a manually pressurized chamber 56 fed through a long handle to spray nozzles adjacent the applicator surface.

James U.S. Pat. No. 2,860,359 shows a fluid reservoir connected via a handle to an applicator having a removable soft portion 32.

Springmeier U.S. Pat. No. 3,029,464 discloses a baster having a pressurized bottle attached to an applicator brush.

Hobbs U.S. Pat. No. 4,008,968 discloses an aperture between the fluid reservoir and the sponge applicator where the fluid is permitted to flow to the sponge applicator.

Fu U.S. Pat. No. 5,186,559 shows flapper valves at the end of the dispenser tubes connecting containers of cooking sauces to brush applicators.

Phelan U.S. Pat. No. 5,570,966 shows another sauce applicator with a push button air release valve attached to the container to control flow to the applicator brush surface.

Pyrozyk, FIG. 5, U.S. Pat. No. 5,547,303 shows a valve moveable between the dotted line position (closed) and the solid line position (open) in a fluid applicator for cooking.

Flores, et al U.S. Pat. No. 6,109,810 show another type of valve (FIGS. 3 and 4) in an applicator attachment from a bottle to a brush portion.

Gessert U.S. Pat. No. 6,192,545 shows a cleaner having a handle and a detachable cleaning pad holder portion.

Gavney, et al. U.S. Pat. No. 6,319,332 show a number of different squeegee structures some of which are designed to contain cleaning fluids directly or to receive fluids from a source.

The Neal et al published application 2004/0019991 shows a grill cleaning tool, which has a curved handle.

### SUMMARY OF THE INVENTION

The present invention has either a disposable or reusable container of cooking oil. The container is inter-fit and held in place on an applicator. The cooking oil is then permitted to flow from the container through the applicator for use on a grill surface. A removable handle may be snap fit onto the applicator.

The applicator includes a sponge and/or scrubber surface for contacting the grill to apply the liquid to the grill. The sponge is attached to a carriage for the container. The carriage as a plurality of apertures formed therein to permit the cooking oil from the container to spread over and through the sponge.

While shown and described as used with cooking oil and a barbecue grill, the invention may also be utilized on other cooking or household surfaces as well as directly onto a human body and with other fluids such as soaps, lotions, or other cleaners.

A principal object of the invention is the provision a cooking oil dispenser for use with a barbecue grill.

Another object of the invention is to enable safe application of cooking oil to a barbecue grill.

A still further object of the invention is the provision of a device of the class described which uses a pre-filled disposable fluid container.

A still further object of the invention is the provision of a barbecue grill oiler, which can be disassembled for cleaning.

The foregoing, as well as further objects and advantages of the invention will become apparent to those skilled in the art from a review of the following detailed description of my invention, reference being made to the accompanying drawings.

### BRIEF DESCRIPTION OF THE DRAWINGS

FIG. 1 is a side view of the preferred embodiment of the invention:

FIG. 2 is a perspective view of a portion of the handle shown in FIG. 1;

FIG. 3 is a perspective view of the opposite end of the handle shown in FIG. 2;

FIGS. 3A-3B are perspective views of alternative structures to that shown in FIG. 3;

FIG. 3C is a sectional view taken along the line A-A of FIG. 3;

FIG. 4 is an exploded view of a portion of the oiler housing shown in FIG. 1;

FIG. 5 is perspective view of a portion of the outer housing shown in FIG. 1;

FIG. 6 is an exploded perspective view of the oiler carriage;

FIG. 7 is a perspective view of a portion of the outer housing; and

FIG. 8 is a front view of the portion of the outer housing shown in FIG. 7.

### DETAILED DESCRIPTION OF THE PREFERRED EMBODIMENT

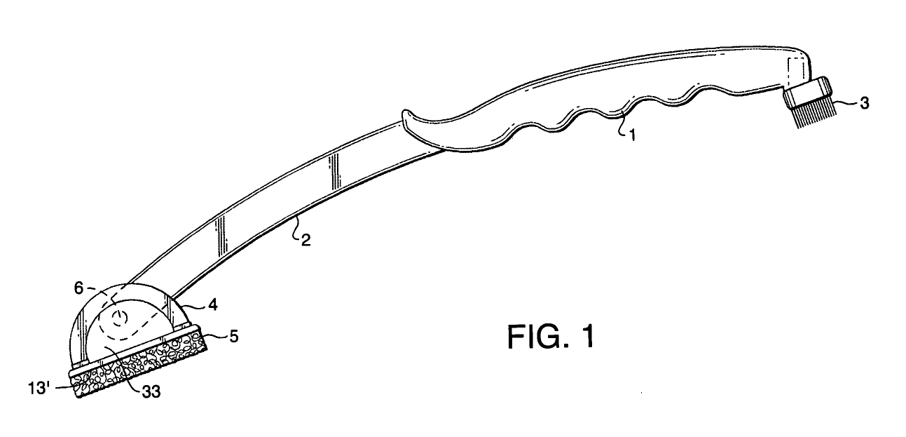

Like reference numerals have been used to designate like parts in FIGS. 1-8. As shown in FIG. 1, an elongated curved handle has a handgrip portion 1 attached to a shaft 2. A grill cleaning brush 3 is removeably attached to the end of the handgrip portion 2. An oiler housing 4 is removeably attached to the end of shaft 2. The housing 4 has a sponge applicator 5 attached to base 13′. The housing 4 pivots about pivots point 6.

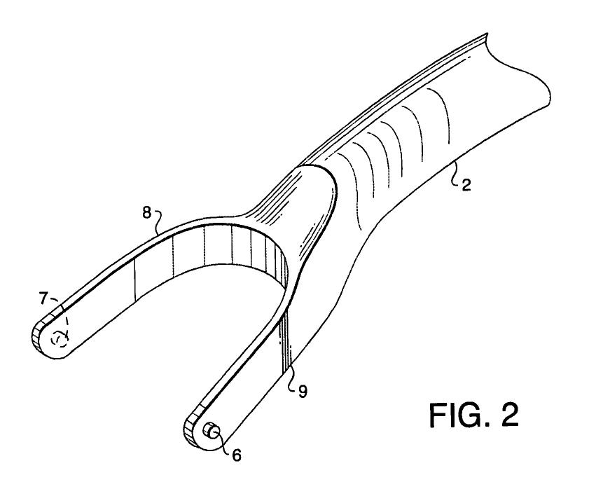

FIG. 2 is a perspective view of the end of the shaft 2, which pivotally mounts the housing 4. The handle as two forked arms 8 and 9 with pivot points 6 and 7 formed outwardly of the forked arms.

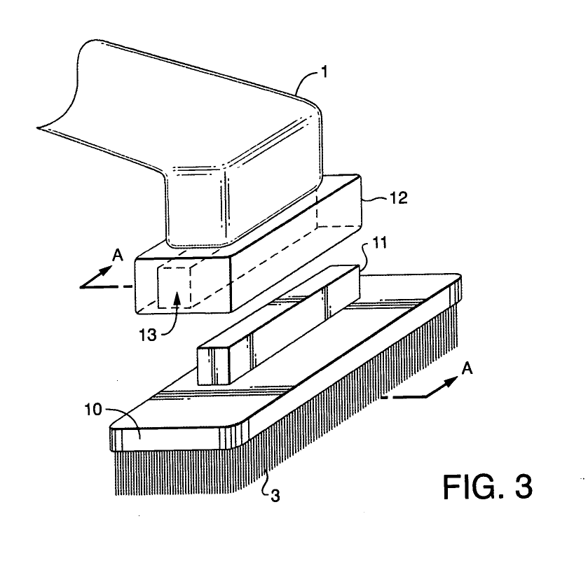

FIG. 3 is a perspective view of the end of the handle grip 1 showing the mounting of the brush 3. The brush 3 which may be a wire brush, has an base 10 on which a rectangular bracket 11 is formed. The bracket 11 fits into a rectangular slot 13 formed in housing 12. This is a frictional engagement so that the brush 3 may be removed for cleaning or replacement. A scrapper may also be used in place of the brush.

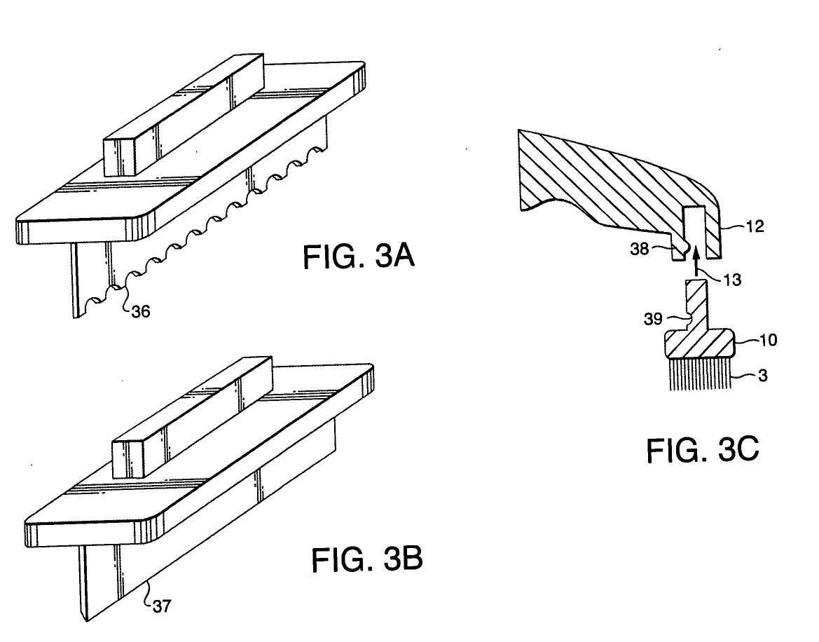

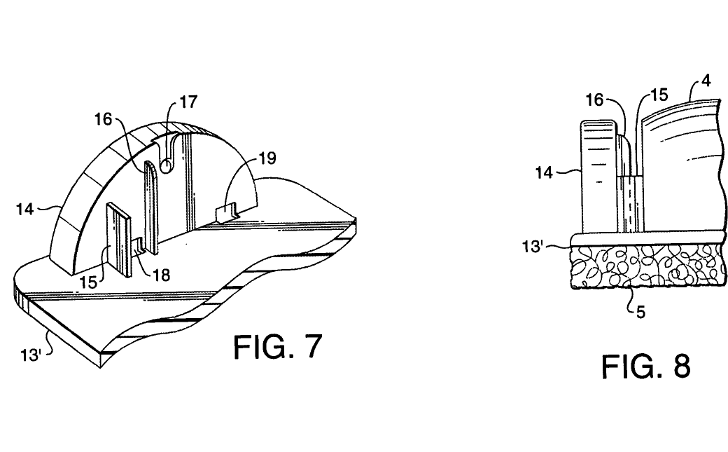

As shown in FIG. 4, the outer housing includes three hollow semi-circular cover portions, namely central portion 4, and lateral portions 14 and 33. These portions are formed on hollow base 13′. The outer housing receives and supports and oiler carriage comprising a base 34 having a plurality of apertures 31 formed therein. Two support walls 27 and 28 are formed on opposite sides of the base. The walls may be braced by supports one of which 32, is shown in FIG. 8. Finally, sponge 5 is attached to the base 34. A tab 20 is formed on the front of the base 34.

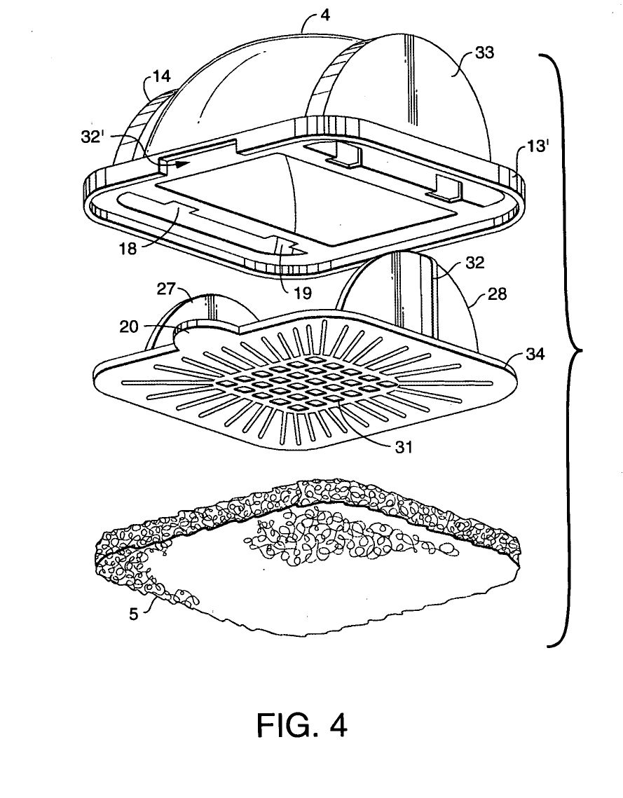

As shown in FIG. 5, the outer housing covers the oiler carriage leaving the sponge 5 exposed for use. The tab 20 fits into slot 32′ in the outer housing (shown in FIG. 8) to aid in manually separating the outer housing and the oiler carriage shown in FIG. 4.

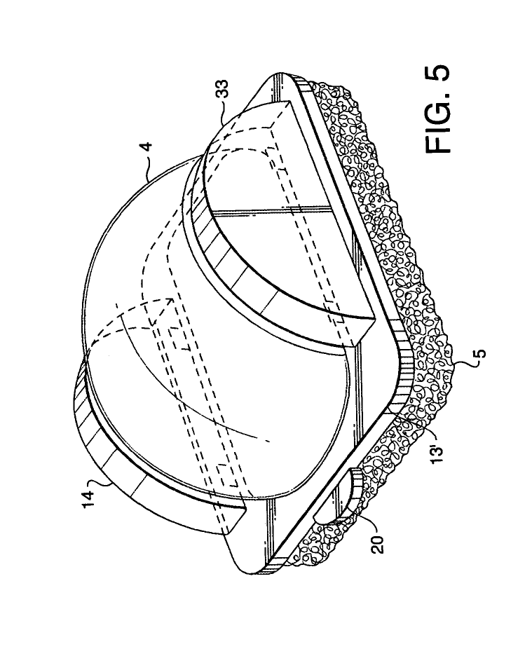

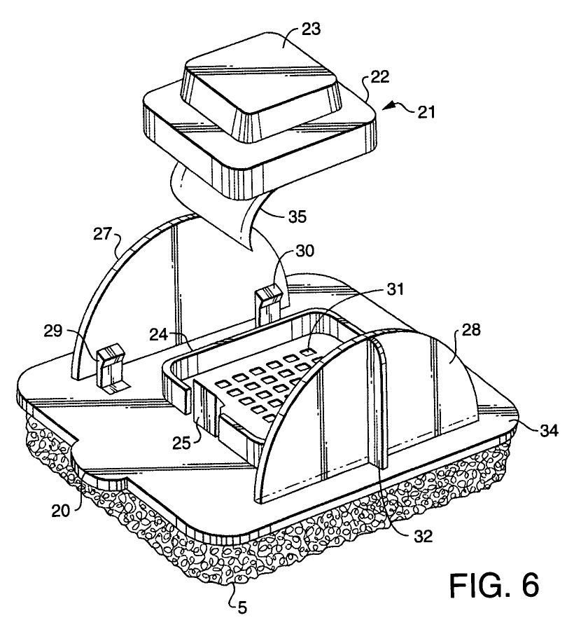

The oil vessel and its mounting onto the oiler carriage is shown in FIG. 6. The oil vessel 21 is a hollow structure filled with cooking oil and has a peel off seal 35, which enables the oil to flow from the vessel. The vessel 21 has a first rectangular base portion 22 and a second smaller rectangular portion 23 formed on the first base portion. This structure creates a supporting ledge to which a hook tab 25 may be attached to hold the vessel 21 against the apertures 31 on the carriage base 34. A support wall 24 is formed around the apertures 31 to aid in supporting the vessel 21 on the carriage base 34. Two other hook tabs 29 and 30 are shown formed on the base 34. These tabs fit into slots 18 and 19 (shown in FIGS. 6-7) to affix the oiler carriage assembly of FIG. 4 to the outer housing 4.

FIGS. 7-8 are detailed perspective views of one end of the mounting of the outer housing 4. Similar structure is provided at the other end of the housing mounting. The handle 2 is pivotally mounted in the hollow housing cover portion 14 of the base 13′ by the engagement of pin 7 in hole 17.

The handle may be disengaged from the pivot points by the use of walls 15 and 16. When the handle is rotated from the position shown in FIG. 1 counterclockwise, it will be disengaged when in contacts the curved upper edge surface portion of the wall 16 and continues along the edge of the wall 16. When the forked portion contacts the top edge of the wall 15, it will aid in the physical separation of the handle and the housing.

The wire brush of FIG. 3 is removable and either the steel scrapper 36 of FIG. 3A or the squeegee 37 of FIG. 3B substituted therefore. The sponge, scrapper or squeegee is additionally secured into the handle with the structure shown in FIG. 3C consisting of a pliable detent 38 formed on an interior wall of slot 13 which cooperates with notch 39 formed on bracket 11.

It will be understood that the oil vessel 21 may be formed in shapes other than that shown in FIG. 6. If formed in other shapes, the outer surface of the vessel should include a ledge so that the locking tab 25 can hold the vessel in place.

It will be also understood that the liquid reservoir could contain commercial or personal cleaning compositions or personal lotions and the invention may be used to dispense these liquids as well.

Further modifications to the invention may be made without departing from the spirit and scope of the invention; accordingly, what is sought to be protected is set forth in the appended claims.

1. Apparatus for applying liquid to a desired surface comprising: an elongated handle; a liquid applicator pivotally attached to one end of said handle, said applicator including a liquid reservoir having a means formed therein for permitting liquid to flow therefrom; a carriage having a plurality of apertures formed therein for removeably supporting said liquid reservoir thereon so that said liquid will flow through said apertures; a sponge attached to said carriage in proximity to said apertures for conveying said liquid to a surface; and cover means removeably attached to said carriage for enclosing said liquid reservoir.

2. The apparatus of claim 2 further including a scraper, squeegee or brush attached to the other end of said handle; said handle having a slot means formed therein and said scraper, squeegee or brush having tab means formed thereon, said tab means being removeably inserted in said slot means for attaching said scraper, squeegee or brush to said handle.

3. The apparatus of claim 1 wherein said carriage includes first hook tab means formed therein for holding said liquid reservoir in place and second hook tab means for attaching said cover means to said carriage; said liquid reservoir and said cover means including respective means formed thereon for cooperating with said hook tab means.

4. The apparatus of claim 1 wherein said elongated handle includes two opposed flexible arms and said applicator is pivotally attached between said arms.

5. The apparatus of claim 4 further including disconnecting means formed in said cover means for disconnecting said applicator from said opposed flexible arms.

6. The apparatus of claim 5 wherein said disconnecting means includes a first wall portion having an elongated edge formed thereon, said edge having a curvilinear upper portion; whereby at least one of said flexible arms may contact said curvilinear upper portion causing said arm to move out of pivotal engagement causing said arm to separate from said applicator.

7. The apparatus of claim 1 wherein said liquid is selected from the group consisting of cooking oil, cleaning compositions or personal care compositions.

8. A liquid dispenser comprising a handle, applicator means removeably attached to said handle, said applicator means including a carriage and a cover; a liquid reservoir; means formed on said carriage for supporting said liquid reservoir; aperture means formed in said carrier beneath said liquid reservoir to permit liquid to flow through said apertures; sponge means attached to said carrier beneath said apertures for receiving said liquid, first fastening means formed on said carrier for holding said liquid reservoir in place, second fastening means formed on said carrier for connecting said carrier to said cover means; and means formed on said cover means for disconnecting said handle and said applicator means.
